(19) United States
(12) Patent Application Publication
(10) Pub. No.: US 2006/0209364 A1
(43) Pub. Date: Sep. 21, 2006

(54) Scanning apparatus and image forming apparatus including the same

(75) Inventor: Kaname Nagatani, Sungnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/331,093

(22) Filed: Jan. 13, 2006

(30) Foreign Application Priority Data
Mar. 17, 2005 (KR) 2005-22343

(51) Int. Cl. H04N 1/04

(52) U.S. Cl. 358/474

(57) ABSTRACT

An image forming apparatus having a scanning apparatus which is adjustable to fit a focal length of a lens according to the scanning apparatus and an image forming apparatus comprising the same. The scanning apparatus comprising a stage glass to seat a paper on an upper surface thereof; a sensor unit pressed and supported toward a planar surface of the stage glass, and comprising a slide way inclined toward the stage glass at a predetermined angle; a slide member supported by the slide way of the sensor unit and provided with an upper end thereof, to contact the stage glass; and a fixing means to fix the slide member to the slide way. Thus, the present invention provides

### CROSS-REFERENCE TO RELATED APPLICATIONS

This application claims the benefit of Korean Patent Application No. 2005-22343, filed on Mar. 17, 2005 in the Korean Intellectual Property Office, the disclosure of which is incorporated herein by reference.

### BACKGROUND OF THE INVENTION

1. Field of the Invention

Aspects of the present invention relate to a scanning apparatus and an image forming apparatus comprising the same, and more particularly, to a scanning apparatus and an image forming apparatus comprising the same, which adjusts an interval between a sensor unit and a stage glass.

2. Description of the Related Art

A scanning apparatus reads an image from a paper and changes the image into data recognizable by a computer. Such a scanning apparatus is an independent device by itself, but recently the scanning apparatus has been incorporated as a part of other devices such as a multi-function product, which performs operations of printing, faxing, scanning, etc. FIGS. 1 and 2 illustrate a configuration of a conventional multi-function product 10. As shown therein, a scanning apparatus 20 is provided on an upper part of the multi-function product 10. The scanning apparatus 20 comprises a main body 21 and a cover 22. The main body 21 comprises a stage glass 23 to seat a paper thereon, and a sensor unit 24 to read the paper. The sensor unit 24 is spaced from a lower surface of the stage glass 23 at a predetermined interval, and elastically supported by a spring 31 provided in a pressure supporting part 30, in an upward direction. The pressure supporting part 30 is guided by a shaft 32 and reciprocates in a horizontal direction. The sensor unit 24 and the pressure supporting part 30 may be driven by a belt-pulley mechanism as disclosed in U.S. Pat. No. 6,055,070 or a shaft-bushing mechanism as disclosed in U.S. Pat. No. 5,379,095.

FIG. 2 is a sectional view of the sensor unit 24 when mounted to the inside of the scanning apparatus 20. A paper 1 which is seated on the stage glass 23 is read through a lens 25 by an image sensor 27 provided on a substrate 26, to change an image on the paper into data. In the conventional multi-function product 10, a focal length (f) between the paper 1 and the lens 25 is maintained by an interval maintaining member 40 which is attached to the sensor unit 24. The interval maintaining member 40 is formed with a projection 41 to constantly maintain the interval between the stage glass 23 and the sensor unit 24. The reference number 28 refers to a light source part.

Meanwhile, the focal length (f) of the lens 25 is variable in each of the scanning devices due to allowable errors in producing the sensor unit 24 or the scanning device 20. Accordingly, the interval maintaining member 40 to be attached to the sensor unit 24 should be prepared based on the projection 41 being at various heights, thereby raising production cost of the scanning device 20.

Also, it takes a significant amount of processing time to measure the focal length (f) of the lens 25 to select the interval maintaining member 40 corresponding thereto, to be attached to the sensor unit 24.

Further, it is difficult to prepare the interval maintaining member 40 having the projection 41 which correctly fits the focal length (f) of the lens 25.

### SUMMARY OF THE INVENTION

Accordingly, it is an aspect of the present invention to provide a scanning apparatus which is adjustable to fit a focal length of a lens according to the scanning apparatus and an image forming apparatus comprising the same.

Also, it is another aspect of the present invention to provide a scanning apparatus and an image forming apparatus, which reduce production cost and processing time to adjust the focal length of the lens.

Additional aspects and/or advantages of the invention will be set forth in part in the description which follows and, in part, will be obvious from the description, or may be learned by practice of the invention.

In accordance with an aspect of the present invention, a scanning apparatus comprising a stage glass to seat a paper on an upper surface thereof; a sensor unit pressed and supported toward a planar surface of the stage glass, and comprising a slide way inclined toward the stage glass at a predetermined angle; a slide member supported by the slide way of the sensor unit and provided with an upper end thereof, to contact the stage glass; and a fixing part to fix the slide member to the slide way is provided.

According to an aspect of the present invention, the slide member further comprises a guide groove formed in parallel with the slide way, and the sensor unit further comprises a guide rod projected to be inserted into the guide groove.

According to an aspect of the present invention, the fixing part comprises a welding coupling between the slide member and the guide rod.

According to an aspect of the present invention, an upper part of the slide member is formed with a projection to contact the stage glass.

In accordance with an aspect of the present invention, an image forming apparatus comprising a scanning apparatus, wherein the scanning apparatus comprises a stage glass to seat a paper on an upper surface thereof, a sensor unit pressed and supported toward a plate surface of the stage glass and comprising a slide way inclined toward the stage glass at a predetermined angle, a slide member supported by the slide way of the sensor unit and provided with an upper part to contact with the stage glass, and a fixing means to fix the slide member to the slide way is provided.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a perspective view of a conventional multi-function product;

FIG. 2 is a partial sectional view illustrating the installation state of a sensor unit of the conventional multi-function product in FIG. 1;

FIG. 3 is a perspective view of a multi-function product according to an embodiment of the present invention;

FIG. 4 is a perspective view of a sensor unit of the multi-function product in FIG. 3;

FIG. 5 is a partial sectional view illustrating the installation state of the sensor unit in FIG. 4; and

FIGS. 6A through 6C illustrate the adjustment state of the sensor unit for maintaining a focal length (f) in FIG. 5.

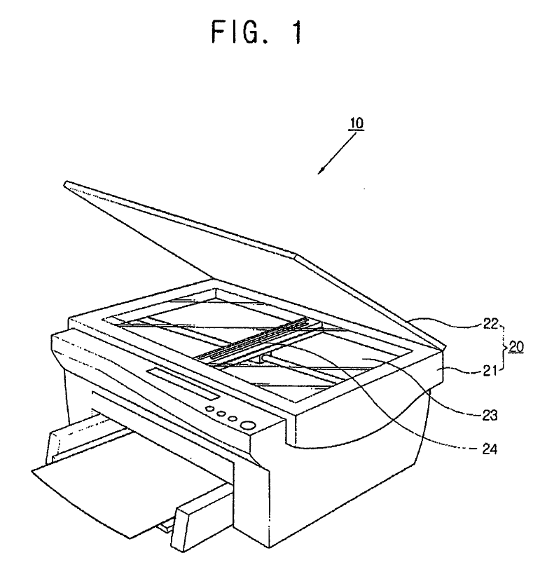

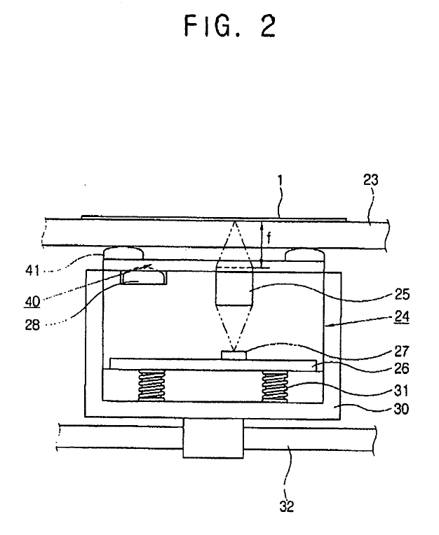

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

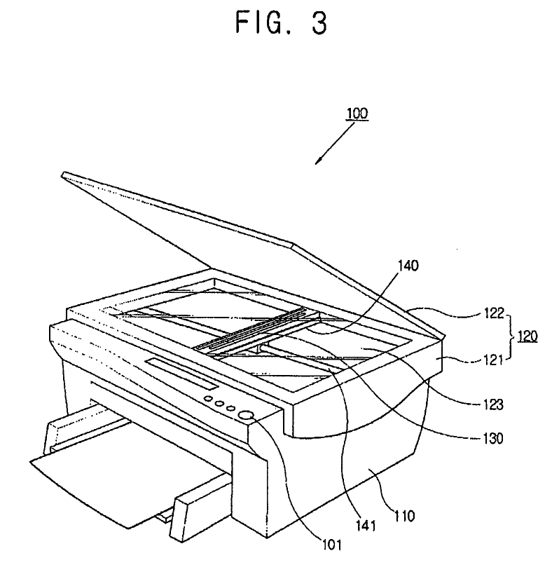

As shown in FIG. 3, an image forming apparatus according to an embodiment of the present invention is provided as a multi-function product 100 in a flat-bed type, which performs operations such as printing, faxing, scanning, etc. The multi-function product 100 comprises a printing apparatus 110 having a controller (not shown) and a control panel 101 connected therewith to perform the printing operation; and a scanning apparatus 120 provided on an upper part of the printing apparatus 110 and coupled with the printing apparatus 110 by a connector such as a hinge. The scanning apparatus 120 comprises a main body 121 and a cover 122. The main body 121 comprises a stage glass 123 to seat a paper thereon and a sensor unit 130 to read the paper. The sensor unit 130 is spaced from a lower surface of the stage glass 123 at a predetermined interval and is supported by a pressure supporting part 140. As the pressure supporting part 140 reciprocates on a shaft 141, the sensor unit 130 reciprocates along the stage glass 123. The movement of the pressure supporting part 140 is performed by a driving unit such as a belt-pulley mechanism, a shaft-bushing mechanism, etc.

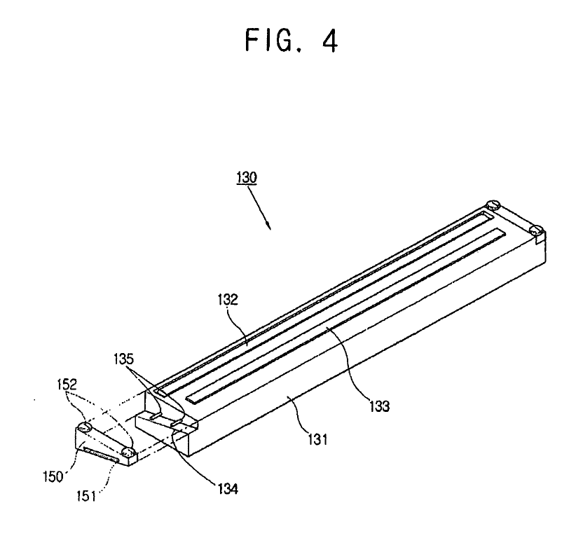

As shown in FIG. 4, the sensor unit 130 comprises a light source 132 and a lens 133 configured to be projected through two openings which are formed on an upper surface of a casing 131. A slide way 134, which is upwardly inclined, is formed on opposite ends of the casing 131. A slide member 150, which has a lower inclined surface corresponding to the slide way 134, is seated on the slide way 134 to be slidably coupled thereto.

Also, a guide groove 151 is formed on the slide member 150 in parallel with the slide way 134. A guide rod 135 is projected from opposite sides of the casing 131 to be inserted into the guide groove 151, thereby controlling a movement direction and distance of the slide member 150. A projection 152 is formed on opposite ends of an upper surface of the slide member 150. After determining a position on the slide way 134 to fit a focal length between the lens 133 of the sensor unit 130 and an upper surface of the stage glass 123, the slide member 150 is fixed to the slide way 134 by being coupled with the guide rod 135 projected to the guide groove 151. The slide member 150 may be fixed by a suitable attachment method such as welding, bonding, etc.

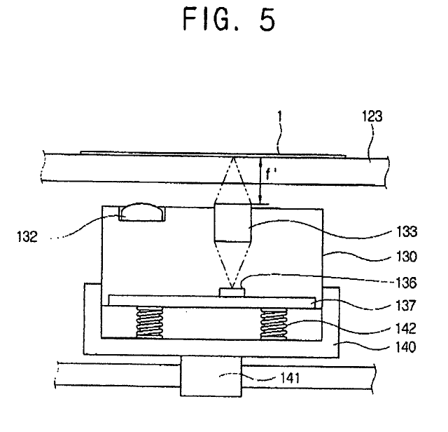

FIG. 5 illustrates the state when the sensor unit 130 is disposed in the scanning apparatus 120 shown in FIG. 3. The sensor unit 130 is spaced from the lower surface of the stage glass 123 at the predetermined interval equal to the focal length f, and elastically supported by a spring 142 of the pressure supporting part 140 in an upward direction. The pressure supporting part 140 is guided by a shaft 141 and reciprocates in a horizontal direction along the stage glass 123 by a driving part (not shown). Alternatively, the sensor unit 130 may be elastically pressed in the upward direction through the shaft 141 by providing a spring (not shown) on a lower part of the shaft 141 instead of the spring 142 provided between the sensor unit 130 and the pressure supporting part 140.

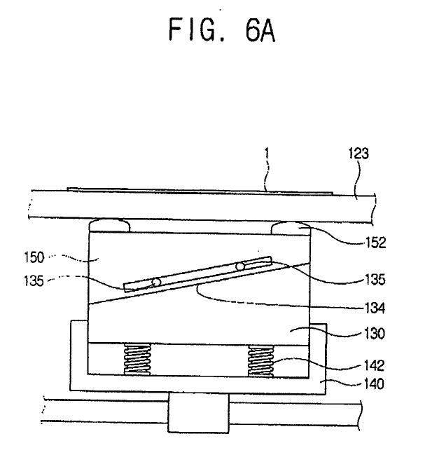

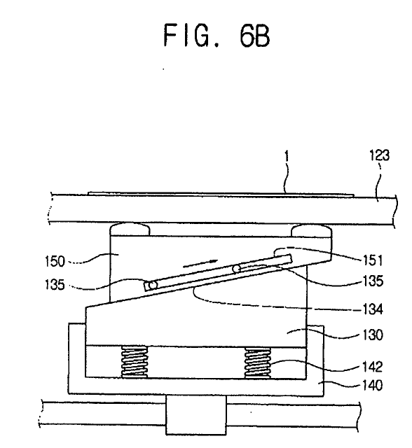

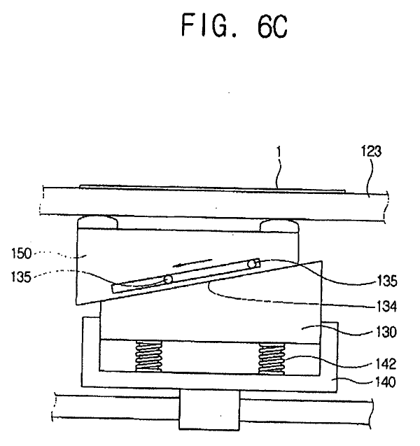

Referring to FIG. 6A, the sensor unit 130 is spaced from the stage glass 123 at the predetermined interval due to the projections 152 formed on the upper part of the slide member 150. The spring 142 provided in the pressure supporting part 140 elastically presses the sensor unit 130 in the upward direction. Because the projections 152 of the slide member 150 disposed on the sensor unit 130 are always in contact with the stage glass 123 by the bias of the spring 142, the predetermined interval between the sensor unit 130 and the stage glass 123 is constantly maintained.

An image sensor 136 for reading a picture and a substrate 137 which is mounted with the image sensor 136 are provided in an internal bottom of the sensor unit 130 as illustrated in FIG. 5. The paper 1 seated on the stage glass 123 reflects light emitted from the light source 132, and the reflected light is read by the image sensor 136 provided on the substrate 137 through the lens 133 and is changed into data corresponding to an image of the paper 1.

The distance between the lens 133 and the stage glass 123 may differ in individual units of the products due to allowable errors of the sensor unit 130, the stage glass 123, etc. The slide member 150 and the slide way 134 may be used to adjust the lens 133 to be spaced from the lower part of the stage glass 123 by as much as the focal length of the lens 133. FIGS. 6A through 6C are side views illustrating the state when the position of the slide member 150 is adjusted for fitting the focal length. FIG. 6A illustrates the position of the slide member 150 and the slide way 134 when the designed focal length and the actual focal length are equal to each other. FIG. 6B illustrates a position of the slide member 150 when the actual focal length is larger than the designed focal length. As shown therein, the slide member 150 is slid in the upward direction of the inclined surface of the slide way 134, and accordingly, the sensor unit 130 moves down along the guide groove 151 toward the pressure supporting part 140. The spring 142 applies pressure in the upward direction as much as the distance the sensor unit 130 moves down. If the actual focal length is smaller than the designed focal length, the slide member 150 is slid in a downward direction of the inclined surface of the slide way 134, and accordingly, the sensor unit 130 moves up toward the stage glass 123 as shown in FIG. 6C. After adjusting the position of the slide member 150, the guide rod 135 is coupled to the slide member 150 by being welded to the slide member 150. Accordingly, the guide rod 135 and the slide member 150 coupled to each other by welding, act as a way to fix the slide member 150 on the slide way 134. Other suitable methods of fixing may also be used such as bonding, gluing, etc. The focal length may be adjusted and fixed during a manufacturing process of the multi-function apparatus.

Because the distance between the sensor unit 130 and the stage glass 123 may be flexibly changed by adjusting the slide member 150 and the slide way 134, the focal length of the lens 139 may be easily correctly adjusted and set.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A scanning apparatus, comprising:
a stage glass to seat a paper on an upper surface thereof;
a sensor unit pressed and supported toward a planar surface of the stage glass, and comprising a slide way at an upper surface, the slide way inclined toward the stage glass at a predetermined angle;
a slide member supported by the slide way of the sensor unit and provided with an upper end thereof, to contact the planar surface of the stage glass; and
fixing means to fix the slide member to the slide way.

2. The scanning apparatus according to claim 1, wherein the slide member further comprises a guide groove formed in parallel with the slide way, and the sensor unit further comprises at least one guide rod projected to be inserted into the guide groove.

3. The scanning apparatus according to claim 1, wherein the fixing means comprises a welding coupling between the slide member and the at least one guide rod.

4. The scanning apparatus according to claim 1, wherein an upper part of the slide member is formed with a projection to contact the stage glass.

5. An image forming device, comprising:
a scanning apparatus having a main body and a cover coupled with the main body, wherein
the scanning apparatus comprises a stage glass to seat a paper on an upper surface thereof, a sensor unit pressed and supported toward a planar surface of the stage glass and comprising a slide way inclined toward the stage glass at a predetermined angle, a slide member supported by the slide way of the sensor unit and provided with an upper part to contact the planar surface of the stage glass, and fixing means to fix the slide member to the slide way.

6. A multi-function image forming apparatus having a transparent plate to support a recording medium, comprising:
a scanning device to scan the recording medium, the scanning device comprising:
a slide member in contact with a lower surface of the transparent plate, the slide member having a first inclined planar surface; and
a sensor unit including a lens and a light source, biased against the slide member to press the slide member into contact with the lower surface of the transparent plate, the sensor unit having a second inclined planar surface facing the first inclined planar surface of the slide member,
wherein the sensor unit and the slide member are adjustable such that a desired focal length of the lens is variably set.

7. The image forming apparatus according to claim 6, wherein the sensor unit and the slide member are fixed with respect to each other once the desired focal length is set.

8. The image forming apparatus according to claim 7, wherein the sensor unit is fixed to the slide member by a welding coupling.

9. The image forming apparatus according to claim 7, wherein the slide member further comprises:
a channel to guide a movement of the slide member along a boundary between the first and second inclined planar surfaces.

10. The image forming apparatus according to claim 9, wherein the sensor unit further comprises:
at least one boss to mate with the channel to guide the movement of the slide member along the boundary between the first and second inclined planar surfaces.

11. The image forming apparatus according to claim 6, wherein the slide member further comprises:
a first slide member disposed at a proximate end of the sensor unit; and
a second slide member disposed at a distal end of the sensor unit.

12. The image forming apparatus according to claim 6, further comprising:
a carriage to support the sensor unit and the slide member; and
a biasing unit disposed between the carriage and the sensor unit, wherein the carriage couples with a guide shaft of the image forming apparatus to control movement of the sensor unit during scanning of the recording medium.

13. A scanning device for use in an image forming apparatus to scan a recording medium, the scanning device comprising:
a slide member in contact with a transparent scanning surface of the image forming apparatus, the slide member having a first inclined planar surface on a bottom side; and
a sensor unit biased against the slide member to press the slide member into contact with the transparent scanning surface, the sensor unit having a second inclined planar surface adjacent the first inclined planar surface of the slide member such that movement of the slide member adjusts the position of the sensor unit up and down to set a focal length of a lens in the sensor unit.

14. The scanning device according to claim 13, wherein the sensor unit and the slide member are fixed with respect to each other once the desired focal length is set.

15. The scanning device according to claim 14, wherein the sensor unit is fixed to the slide member by a welding coupling.

16. The scanning device according to claim 13, wherein the slide member further comprises:
a channel to guide the movement of the slide member along the second inclined planar surface of the sensor unit.

17. The scanning device according to claim 13, wherein the slide member further comprises:
a first slide member disposed at a proximate end of the sensor unit; and
a second slide member disposed at a distal end of the sensor unit.

18. The scanning device according to claim 13, further comprising:
a carriage to support the sensor unit and the slide member; and
a biasing unit disposed between the carriage and the sensor unit, wherein the carriage couples with a guide shaft of the image forming apparatus.

19. A scanning device for use in an image forming apparatus to scan a recording medium, the scanning device comprising:
a sensor unit to scan the recording medium;
an adjuster to adjust the position of the sensor unit vertically to set a focal length of a lens in the sensor unit.

20. The scanning device according to claim 19, further comprising:
a carriage to support the sensor unit; and
a biasing unit disposed between the carriage and the sensor unit, wherein the carriage couples with a guide shaft of the image forming apparatus.
